(19) United States
(12) Patent Application Publication
(10) Pub. No.: US 2017/0363038 A1
(43) Pub. Date: Dec. 21, 2017

(54) CYLINDER BLOCK FOR INTERNAL COMBUSTION ENGINE AND METHOD FOR PRODUCING SAME

(71) Applicant: TOYOTA JIDOSHA KABUSHIKI KAISHA, Toyota-shi (JP)

(72) Inventor: Kaoru ITO, Okazaki-shi (JP)

(73) Assignee: TOYOTA JIDOSHA KABUSHIKI KAISHA, Toyota-shi (JP)

(21) Appl. No.: 15/490,264

(22) Filed: Apr. 18, 2017

(30) Foreign Application Priority Data
Jun. 16, 2016 (JP) 2016-119938

(51) Int. Cl. F02F 1/14; F02F 1/00; F02F 7/00

(52) U.S. Cl. CPC F02F 1/14; F02F 7/0021; F02F 1/004; F02F 2200/00; F02F 2007/0041

(57) ABSTRACT

A cylinder block for an internal combustion engine includes a metal section and a resin section. The metal section includes: a cylinder liner; head bolt female screw portions that are screwed onto male screw portions of head bolts that fasten the cylinder block and a cylinder head; crank cap bolt female screw portions that are screwed onto male screw portions of crank cap bolts that fasten the cylinder block and crank caps and columnar portions that connect the head bolt female screw portions; and the crank cap bolt female screw portions. The cylinder liner and the columnar portions are integrated with each other.

### CROSS-REFERENCE TO RELATED APPLICATION

This application is based on and claims the benefit of Japanese Patent Application No. 2016-119938, filed on Jun. 16, 2016, which is incorporated by reference herein in its entirety.

### BACKGROUND

### Technical Field

The present disclosure relates to a cylinder block for an internal combustion engine including a metal section and a resin section, and a method for producing the same.

### Background Art

There is known a cylinder block for an internal combustion engine including a metal section and a resin section. An example of the cylinder block for an internal combustion engine of this kind is described in JP 05-296103 A, for example.

In the cylinder block for an internal combustion engine described in JP 05-296103 A, a water jacket wall (that is, a member forming the outer wall of a water jacket) is formed with a resin material.

JP 05-296103 A is a patent document which may be related to the present disclosure.

### SUMMARY

JP 05-296103 A does not describe a head bolt female screw portion that is screwed onto a head bolt male screw portion of a head bolt that fastens the cylinder block and a cylinder head. Further, in JP 05-296103 A, a screw head of a crank cap bolt that fastens the cylinder block and a bearing cap (crank cap) is illustrated, but a crank cap bolt female screw portion that is screwed onto a male screw portion thereof is not described.

Even if the head bolt female screw portion and the crank cap bolt female screw portion are formed with a metal material, where the head bolt female screw portion and the crank cap bolt female screw portion are connected via a resin section formed by a resin material, the resin section may be deformed when a large upward load is applied to the head bolt female screw portion by a large fastening force of the head bolt. Further, when a large downward load is applied to a crankshaft due to a combustion pressure, and with this, a large downward load is applied to the crank cap bolt female screw portion, the resin section may also be deformed.

Further, JP 05-296103 A does not describe a cylinder liner.

If a cylinder liner is provided and a configuration that restrains deformation of the cylinder liner is not provided, the cylinder liner is pushed downward via a head gasket at the time of fastening the head bolt, for example, and with this, the cylinder liner may be deformed.

In the light of the aforementioned problem, the present disclosure has an object to provide a cylinder block for an internal combustion engine that can restrain deformation of a resin section and a cylinder liner and a method for manufacturing the same.

A cylinder block for an internal combustion engine according to the present disclosure includes: a metal section formed with a metal material; and a resin section. The metal section includes: a cylinder liner; a head bolt female screw portion that is screwed onto a male screw portion of a head bolt that fastens the cylinder block and a cylinder head; a crank cap bolt female screw portion that is screwed onto a male screw portion of a crank cap bolt that fastens the cylinder block and a crank cap; and a columnar portion that connects the head bolt female screw portion and the crank cap bolt female screw portion. The cylinder liner and the columnar portion are integrated with each other.

Namely, in the cylinder block for an internal combustion engine according to the present disclosure, the cylinder block is configured by the metal section and the resin section. Further, the head bolt female screw portion that is formed with a metal material and the crank cap bolt female screw portion that is formed with a metal material are joined and integrated with each other with, interposed therebetween, the columnar portion that is formed with a metal material.

Consequently, in the cylinder block for an internal combustion engine according to the present disclosure, when a large upward load is applied to the head bolt female screw portion by a large fastening force of the head bolt, the load is received by the columnar portion. That is, the load is not directly applied to the resin section. Further, when a large downward load is applied to the crankshaft by a combustion pressure, and with this, a large downward load is applied to the crank cap bolt female screw portion, the load is received by the columnar portion. That is, the load is not directly applied to the resin section.

As a result, the cylinder block for an internal combustion engine according to the present disclosure can reduce the possibility that the resin section of the cylinder block is deformed by a large fastening force of the head bolt or a combustion pressure.

Furthermore, in the cylinder block for an internal combustion engine according to the present disclosure, the cylinder liner is integrated with the columnar portion that is formed with a metal material.

Consequently, in the cylinder block for an internal combustion engine according to the present disclosure, when a downward load that pushes the cylinder liner is applied to the cylinder liner via a head gasket at the time of fastening of the head bolt, the load is received by the columnar portion.

As a result, in the cylinder block for an internal combustion engine according to the present disclosure, deformation of the cylinder liner can be restrained compared with an example where the downward load that pushes the cylinder liner at the time of fastening of the head bolt is applied to only the cylinder liner.

In the cylinder block for an internal combustion engine according to the present disclosure, the cylinder liner may include at least a first cylinder liner and a second cylinder liner. The metal section may include: a beam-shaped portion that is disposed between the first cylinder liner and the second cylinder liner and that joins the first cylinder liner and the second cylinder liner; and a crank journal portion that slides in contact with a crank journal. The head bolt female screw portion may include a first head bolt female screw portion that is disposed at one end portion of the beam-shaped portion, and a second head bolt female screw portion that is disposed at the other end portion of the beam-shaped portion. The columnar portion may include a first columnar portion and a second columnar portion. The crank cap bolt female screw portion may include a first crank cap bolt female screw portion that is connected to the first head bolt female screw portion via the first columnar portion, and a second crank cap bolt female section that is connected to the second head bolt female screw portion via the second columnar portion. The crank journal portion may connect the first crank cap bolt female screw portion and the second crank cap bolt female screw portion. The first cylinder liner, the second cylinder liner, the beam-shaped portion, the first columnar portion, the second columnar portion and the crank journal portion may be integrated with each other.

Namely, in the aforementioned cylinder block for an internal combustion engine, the first cylinder liner and the second cylinder liner are joined via the beam-shaped portion. That is, the first cylinder liner and the beam-shaped portion 1a5b are joined to each other, and further, the beam-shaped portion and the second cylinder liner are joined to each other.

Consequently, in the aforementioned cylinder block for an internal combustion engine, an outer circumferential surface of a cylindrical first cylinder liner and an outer circumferential surface of a cylindrical second cylinder liner are directly joined to each other, and the strength of the joint between the first cylinder liner and the second cylinder liner can be enhanced compared with an example where the surface of the joint between the first cylinder liner and the second cylinder liner is very small.

Furthermore, in the aforementioned cylinder block for an internal combustion engine, the first head bolt female screw portion and the second head bolt female screw portion are provided. Also, the first head bolt female screw portion and the second head bolt female screw portion are formed in the beam-shaped portion and are integrated with the beam-shaped portion.

Consequently, in the aforementioned cylinder block for an internal combustion engine, the rigidity with respect to the fastening force of the head bolt can be enhanced compared with an example where the first head bolt female screw portion and the second head bolt female screw portion are configured as separate metal sections.

Further, in the aforementioned cylinder block for an internal combustion engine, the first crank cap bolt female screw portion and the second crank cap bolt female screw portion are provided. Also, the first crank cap bolt female screw portion and the second crank cap bolt female screw portion are connected via the crank journal portion.

Consequently, in the aforementioned cylinder block for an internal combustion engine, the rigidity with respect to a combustion pressure can be enhanced compared with an example where the first crank cap bolt female screw portion and the second crank cap bolt female screw portion are configured as separate metal portions.

Furthermore, in the aforementioned cylinder block for an internal combustion engine, the first columnar portion that connects the first head bolt female screw portion and the first crank cap bolt female screw portion, and the second columnar portion that connects the second head bolt female screw portion and the second crank cap bolt female screw portion are integrated via the beam-shaped portion and the crank journal portion.

Consequently, in the aforementioned cylinder block for an internal combustion engine, the rigidity with respect to the fastening force of the head bolt and the combustion pressure can be enhanced compared with an example where the first columnar portion and the second columnar portion are configured as separate metal portions.

In the cylinder block for an internal combustion engine according to the present disclosure, the first columnar portion may include a first support portion that supports a bottom portion of the first cylinder liner, and a second support portion that supports a bottom portion of the second cylinder liner. Also, the second columnar portion may include a third support portion that supports the bottom portion of the first cylinder liner, and a fourth support portion that supports the bottom portion of the second cylinder liner.

Namely, in the aforementioned cylinder block for an internal combustion engine, the bottom portion of the first cylinder liner is supported by the first support portion provided at the first columnar portion and the third support portion provided at the second columnar portion, and the bottom portion of the second cylinder liner is supported by the second support portion provided at the first columnar portion and the fourth support portion provided at the second columnar portion.

Consequently, when the first cylinder liner and the second cylinder liner are pushed downward via the head gasket at the time of fastening of the head bolt, the aforementioned cylinder block for an internal combustion engine can reduce the possibility of the first cylinder liner and the second cylinder liner being deformed, in detail, the possibility of the first cylinder liner and the second cylinder liner being separated from the beam-shaped portion, compared with an example where the first support portion and the third support portion are not provided at the first columnar portion and the second support portion and the fourth support portion are not provided at the second columnar portion.

In the method for producing the cylinder block for an internal combustion engine according to the present disclosure, wherein, after a water jacket outer wall member made of a resin for forming a water jacket and the metal section are integrated with each other, the metal section and the water jacket outer wall member may be wrapped by casting with a casting resin material that forms the resin section.

Namely, in the method for producing the aforementioned cylinder block for an internal combustion engine, the water jacket outer wall member is not formed with a casting resin material at the time of the metal section being wrapped by casting with the casting resin material that forms the resin section, but the water jacket outer wall member which is formed with a resin material is joined to the metal section before the metal section is wrapped by casting with the casting resin material forming the resin section. Further, after the water jacket outer wall member is joined to the metal section, the metal section and the water jacket outer wall member are wrapped by casting with the casting resin material.

Consequently, in the method for producing the aforementioned cylinder block for an internal combustion engine, the sealing performance of the water jacket can be enhanced compared with an example illustrated in FIG. 8 in JP 05-296103 A.

According to the present disclosure, deformation of the resin section and the cylinder liner can be restrained.

### BRIEF DESCRIPTION OF THE DRAWINGS

FIG. 1 is a schematic perspective view of a cylinder block 1 for an internal combustion engine according to a first embodiment;

FIG. 2 is a sectional view including the center axis of No. 1 cylinder #1 of the cylinder block 1 for an internal combustion engine according to the first embodiment;

FIG. 3 is a sectional view including the center axes of head bolt screw holes 1b1c and 1b1d of the cylinder block 1 for an internal combustion engine according to the first embodiment;

FIG. 4 is a schematic perspective view of a metal section la, a water jacket outer wall member 1c and a water jacket 1d of the cylinder block 1 (see FIG. 1) for an internal combustion engine according to the first embodiment;

FIG. 5 is a sectional view of the metal section 1a, the water jacket outer wall member 1c and the water jacket 1d including the center axis of No. 1 cylinder #1;

FIG. 6 is a sectional view of the metal section 1a, the water jacket outer wall member 1c and the water jacket 1d including the center axes of head bolt female screw portions 1a2c and 1a2d;

FIGS. 7A and 7B are perspective views illustrating parts on the upper side of bottom portions 1a1a1, 1a1b1, 1a1c1 and 1a1d1 of cylinder liners 1a1a, 1a1b, 1a1c and 1a1d of the metal section 1a illustrated in FIG. 4; and

FIGS. 8A and 8B are perspective views illustrating parts on the upper side of beam-shaped portions 1a5a, 1a5b, 1a5c, 1a5d and 1a5e of the metal section 1a illustrated in FIG. 4.

### DETAILED DESCRIPTION

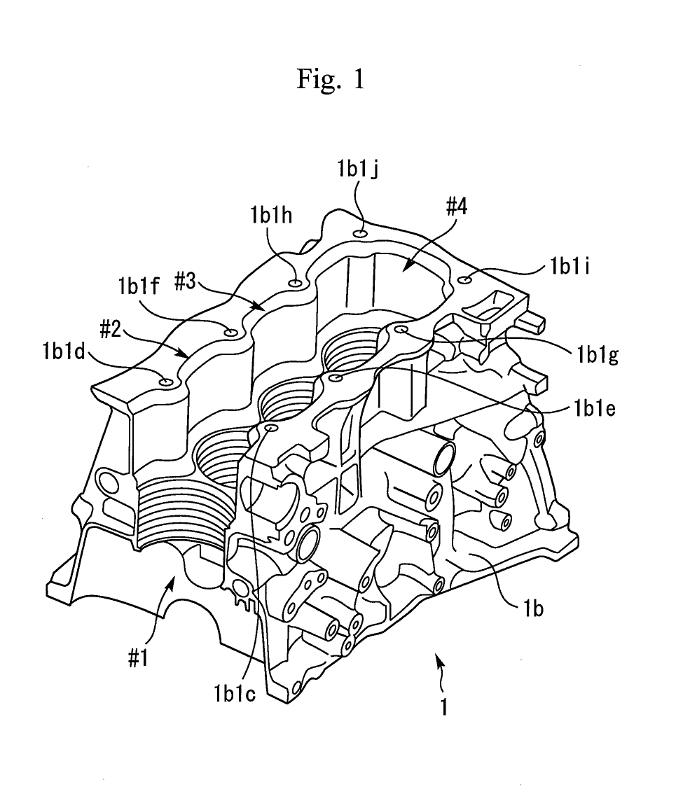

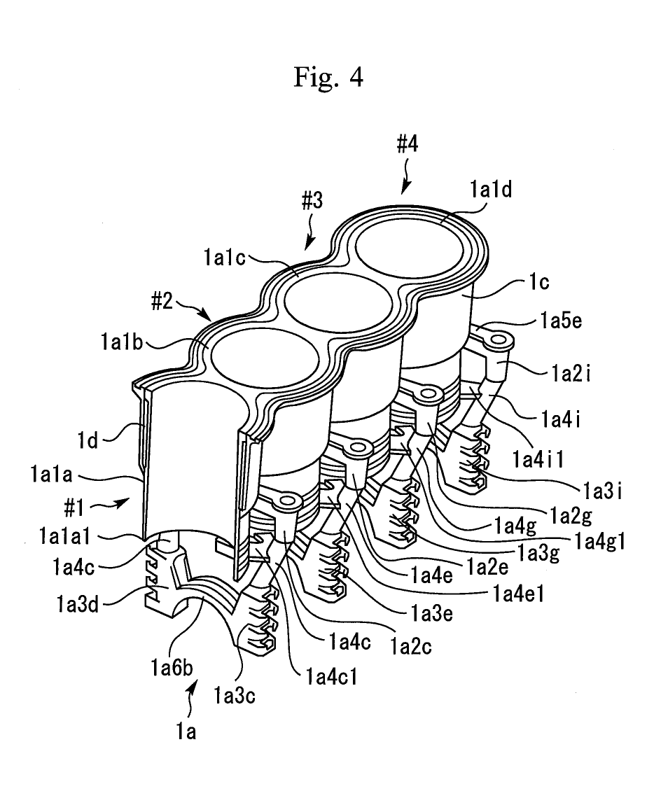

Hereinafter, a first embodiment concerning a cylinder block for an internal combustion engine according to the present disclosure will be described. FIG. 1 is a schematic perspective view of a cylinder block 1 for an internal combustion engine according to the first embodiment. In more detail, FIG. 1 is a perspective view of a metal section 1a (see FIG. 4) that is a part of the cylinder block 1 in through view. Further, in FIG. 1, No. 1 cylinder #1 of the cylinder block 1 is illustrated in section.

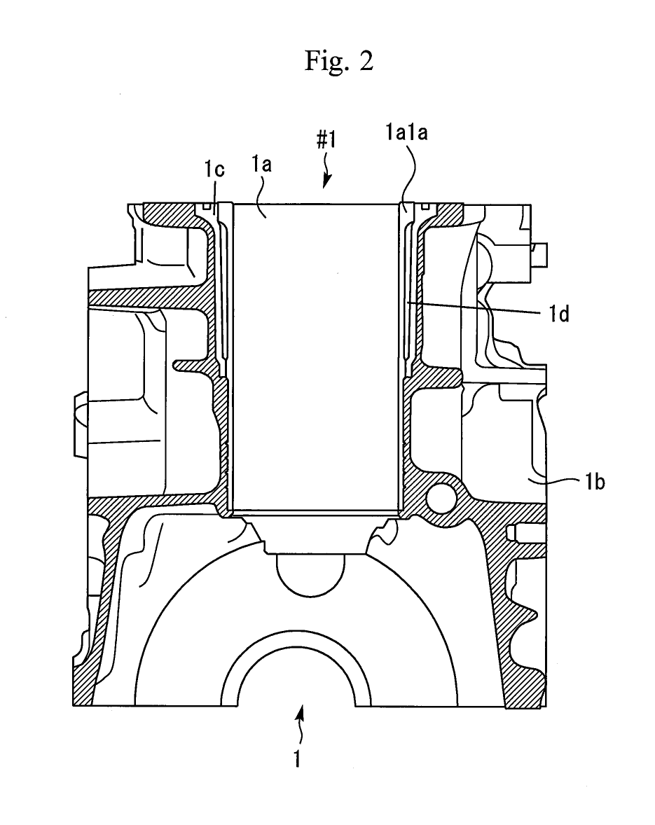

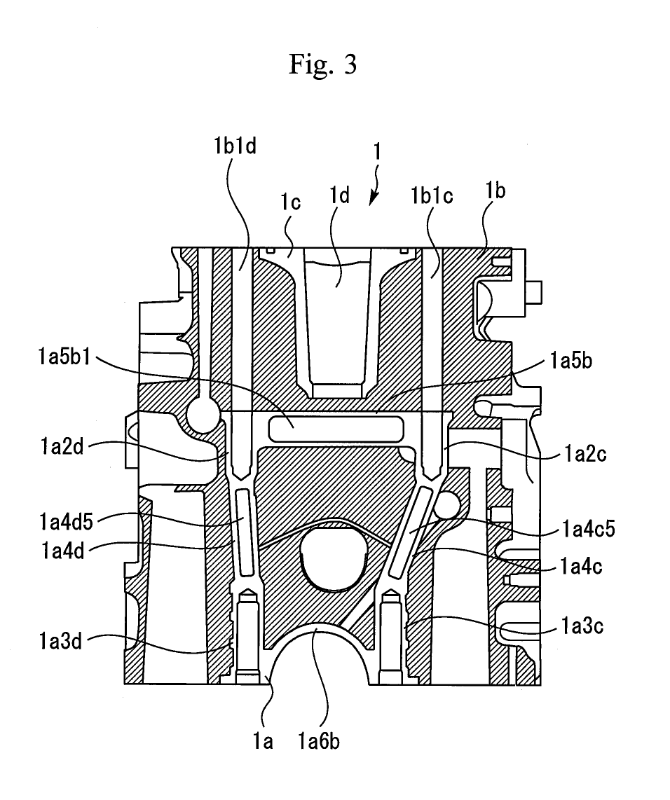

FIG. 2 is a sectional view including the center axis of No. 1 cylinder #1 of the cylinder block 1 for an internal combustion engine according to the first embodiment. FIG. 3 is a sectional view including the center axes of head bolt screw holes 1b1c and 1b1d (see FIG. 1) of the cylinder block 1 for an internal combustion engine according to the first embodiment. In detail, in FIGS. 2 and 3, not only a resin section 1b of the cylinder block 1, but also the metal section 1a, a water jacket outer wall member 1c, and a water jacket 1d that is formed by the metal section 1 a and the water jacket outer wall member 1c are illustrated.

FIG. 4 is a schematic perspective view of the metal section 1a, the water jacket outer wall member 1c and the water jacket 1d of the cylinder block 1 (see FIG. 1) for an internal combustion engine according to the first embodiment. In FIG. 4, No. 1 cylinder #1 is illustrated in section.

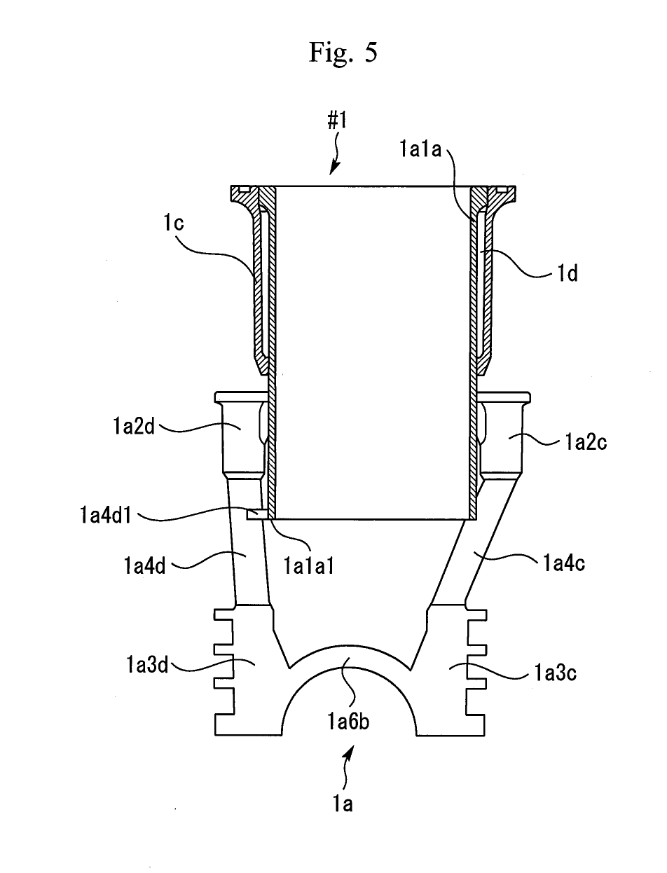

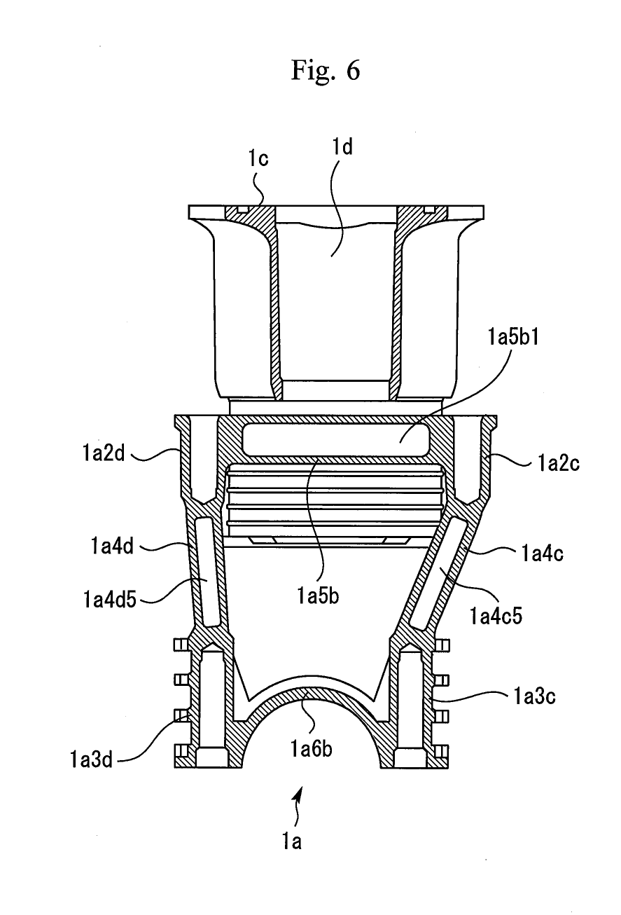

FIG. 5 is a sectional view of the metal section 1a, the water jacket outer wall member 1c and the water jacket 1d including the center axis of No. 1 cylinder #1. FIG. 6 is a sectional view of the metal section 1a, the water jacket outer wall member 1c and the water jacket 1d including the center axes of head bolt female screw portions 1a2c and 1a2d.

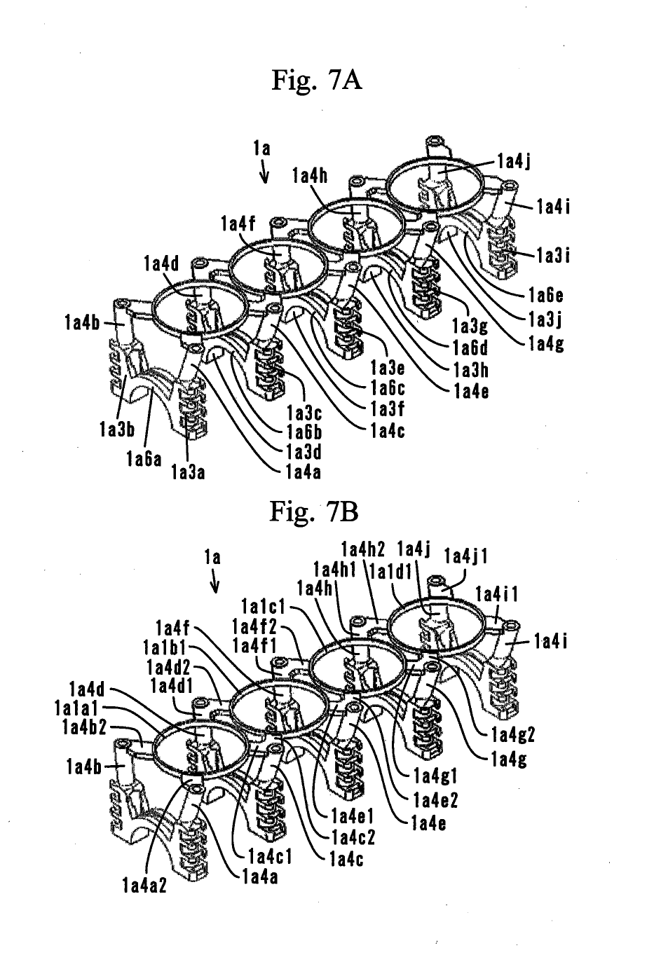

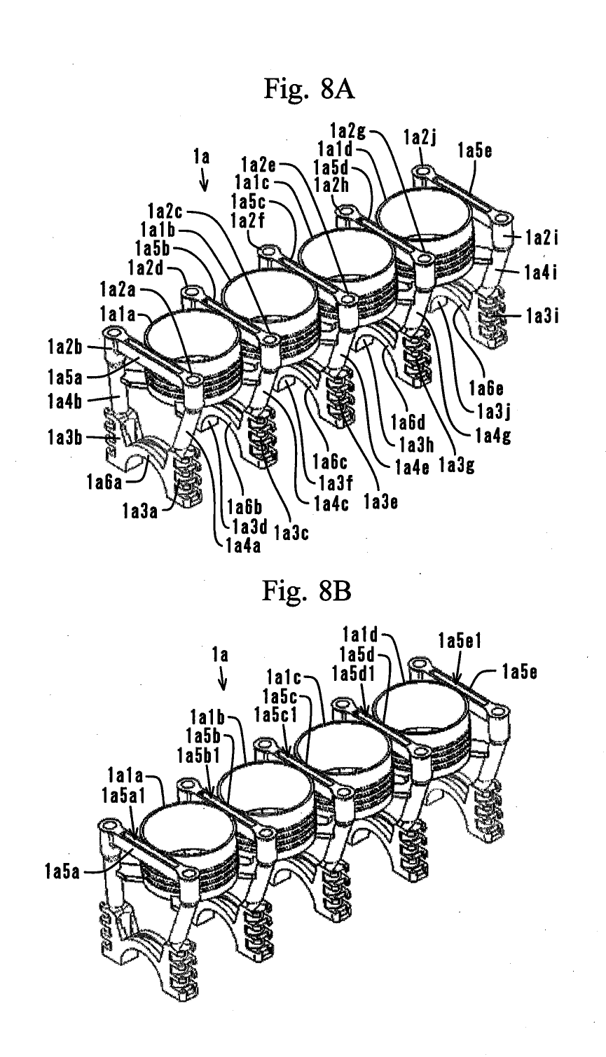

FIGS. 7A and 7B are perspective views illustrating parts on the upper side of bottom portions 1a1a1, 1a1b1, 1a1c1 and 1a1d1 of cylinder liners 1a1a, 1a1b, 1a1c and 1a1d of the metal section 1a illustrated in FIG. 4. In detail, FIGS. 7A and 7B differ only in indication of reference signs, and are common in substantial part. FIGS. 8A and 8B are perspective views illustrating parts on the upper side of beam-shaped portions 1a5a, 1a5b, 1a5c, 1a5d and 1a5e of the metal section 1a illustrated in FIG. 4. In detail, FIGS. 8A and 8B differ only in indication of reference sings, and are common in substantial part.

In the cylinder block 1 for an internal combustion engine of the first embodiment, the metal section 1a (see FIG. 4) that is formed with a metal material, and a resin section 1b (see FIG. 1) that is formed with a casting resin material are provided.

In the example illustrated in FIG. 4 to which the cylinder block 1 for an internal combustion engine of the first embodiment is applied, in the metal section 1a, the cylinder liner 1a1a for No. 1 cylinder #1, the cylinder liner 1a1b for No. 2 cylinder #2, the cylinder liner 1a1c for No. 3 cylinder #3, and the cylinder liner 1a1d for No. 4 cylinder #4 are provided. The cylinder liners 1a1a, 1a1b, 1a1c and 1a1d can be formed with a ferrous metal material, or aluminum, for example.

Further, in the example illustrated in FIGS. 4, 6, 8A and 8B to which the cylinder block 1 for an internal combustion engine of the first embodiment is applied, head bolt female screw portions 1a2a, 1a2b, 1a2c, 1a2d, 1a2e, 1a2f, 1a2g, 1a2h, 1a2i and 1a2j that are screwed onto male screw portions (not illustrated) of head bolts (not illustrated) that fasten the cylinder block 1 and a cylinder head (not illustrated) are provided in the metal section 1a. That is, in the example illustrated in FIGS. 4, 6, 8A and 8B, ten head bolts are used to fasten the cylinder block 1 and the cylinder head, and ten head bolt female screw portions 1a2a, 1a2b, 1a2c, 1a2d, 1a2e, 1a2f, 1a2g, 1a2h, 1a2i and 1a2j are formed in the metal section 1a.

In the example illustrated in FIGS. 1, 3, 4, 6, 8A and 8B, a head bolt screw hole 1b1c (see FIGS. 1 and 3) corresponding to the head bolt female screw portion 1a2c (see FIGS. 3, 4, 6, 8A and 8B) of the metal section 1a is formed in the resin section 1b. Also, a head bolt screw hole 1b1d (see FIGS. 1 and 3) corresponding to the head bolt female screw portion 1a2d (see FIGS. 3, 6, 8A and 8B) of the metal section 1a is formed in the resin section 1b. Likewise, head bolt screw holes (not illustrated) corresponding to the head bolt female screw portions 1a2a and 1a2b (see FIGS. 8A and 8B) of the metal section 1a are formed in the resin section 1b. Further, head bolt screw holes 1b1e, 1b1f, 1b1g, 1b1h, 1b1i and 1b1j (see FIG. 1) corresponding to the head bolt female screw portions 1a2e, 1a2f, 1a2g, 1a2h, 1a2i and 1a2j (see FIGS. 8A and 8B) of the metal section 1a are formed in the resin section 1b.

In the example illustrated in FIGS. 3 and 6 to which the cylinder block 1 for an internal combustion engine of the first embodiment is applied, crank cap bolt female screw portions 1a3c and 1a3d that are screwed onto male screw portions (not illustrated) of crank cap bolts (not illustrated) that fasten the cylinder block 1 and crank caps (not illustrated) are provided in the metal section 1a. Likewise, in the example illustrated in FIG. 7A, crank cap bolt female screw portions 1a3a, 1a3b, 1a3e, 1a3f, 1a3g, 1a3h, 1a3i and 1a3j that are screwed onto male screw portions of the crank cap bolts that fasten the cylinder block 1 and the crank caps are provided in the metal section 1a.

Further, in the example illustrated in FIGS. 3 and 6 to which the cylinder block 1 for an internal combustion engine of the first embodiment is applied, the metal section 1a is provided with a columnar portion 1a4c that connects the head bolt female screw portion 1a2c and the crank cap bolt female screw portion 1a3c, and a columnar portion 1a4d that connects the head bolt female screw portion 1a2d and the crank cap bolt female screw portion 1a3d.

Likewise, in the example illustrated in FIG. 4, the metal section 1a is provided with a columnar portion 1a4e that connects the head bolt female screw portion 1a2e and the crank cap bolt female screw portion 1a3e, a columnar portion 1a4g that connects the head bolt female screw portion 1a2g and the crank cap bolt female screw portion 1a3g, and a columnar portion 1a4i that connects the head bolt female screw portion 1a2i and the crank cap bolt female screw portion 1a3i. Further, in the example illustrated in FIG. 8A, the metal section 1a is provided with a columnar portion 1a4a that connects the head bolt female screw portion 1a2a and the crank cap bolt female screw portion 1a3a, a columnar portion 1a4b that connects the head bolt female screw portion 1a2b and the crank cap bolt female screw portion 1a3b, a columnar portion 1a4f (see FIG. 7A) that connects the head bolt female screw portion 1a2f and the crank cap bolt female screw portion 1a3f, a columnar portion 1a4h (see FIG. 7A) that connects the head bolt female screw portion 1a2h and the crank cap bolt female screw portion 1a3h, and a columnar portion 1a4j (see FIG. 7A) that connects the head bolt female screw portion 1a2j and the crank cap bolt female screw portion 1a3j.

In the example illustrated in FIGS. 3 and 6 to which the cylinder block 1 for an internal combustion engine of the first embodiment is applied, hollow portions 1a4c5 and 1a4d5 are provided in the columnar portions 1a4c and 1a4d, and reduction in weights of the columnar portions 1a4c and 1a4d is thus achieved. However, in another example to which the cylinder block 1 for an internal combustion engine of the first embodiment is applied, the hollow portions 1a4c5 and 1a4d5 may be omitted instead.

Furthermore, in the example illustrated in FIG. 8A to which the cylinder block 1 for an internal combustion engine of the first embodiment is applied, the metal section 1a is provided with the beam-shaped portions 1a5a, 1a5b, 1a5c, 1a5d and 1a5e. The head bolt female screw portion 1a2a is disposed at one end portion of the beam-shaped portion 1a5a, and the head bolt female screw portion 1a2b is disposed at the other end portion of the beam-shaped portion 1a5a. Likewise, the head bolt female screw portion 1a2c is disposed at one end portion of the beam-shaped portion 1a5b, and at the other end portion of the beam-shaped portion 1a5b, the head bolt female screw portion 1a2d is disposed. Further, the head bolt female screw portion 1a2e is disposed at one end portion of the beam-shaped portion 1a5c, and the head bolt female screw portion 1a2f is disposed at the other end portion of the beam-shaped portion 1a5c. The head bolt female screw portion 1a2g is disposed at one end portion of the beam-shaped portion 1a5d, and the head bolt female screw portion 1a2h is disposed at the other end portion of the beam-shaped portion 1a5d. The head bolt female screw portion 1a2i is disposed at one end portion of the beam-shaped portion 1a5e, and the head bolt female screw portion 1a2j is disposed at the other end portion of the beam-shaped portion 1a5e.

In the example illustrated in FIGS. 6 and 8B to which the cylinder block 1 for an internal combustion engine of the first embodiment is applied, hollow portions 1a5a1, 1a5b1, 1a5c1, 1a5d1 and 1a5e1 are provided in the beam-shaped portions 1a5a, 1a5b, 1a5c, 1a5d and 1a5e, and reduction in weights of the beam-shaped portions 1a5a, 1a5b, 1a5c, 1a5d and 1a5e is thus achieved. However, in another example to which the cylinder block 1 for an internal combustion engine of the first embodiment is applied, the hollow portions 1a5a1, 1a5b1, 1a5c1, 1a5d1 and 1a5e1 may be omitted instead.

Further, in the example illustrated in FIG. 8A to which the cylinder block 1 for an internal combustion engine of the first embodiment is applied, the beam-shaped portion 1a5b is disposed between the cylinder liner 1a1a and the cylinder liner 1a1b and joins the cylinder liner 1a1a and the cylinder liner 1a1b.

Likewise, in the example illustrated in FIG. 8A to which the cylinder block 1 for an internal combustion engine of the first embodiment is applied, the beam-shaped portion 1a5c is disposed between the cylinder liner 1a1b and the cylinder liner 1a1c and joins the cylinder liner 1a1b and the cylinder liner 1a1c. Furthermore, the beam-shaped portion 1a5d is disposed between the cylinder liner 1a1c and the cylinder liner 1a1d and joins the cylinder liner 1a1c and the cylinder liner 1a1d.

Further, in the example illustrated in FIG. 8A to which the cylinder block 1 for an internal combustion engine of the first embodiment is applied, the beam-shaped portion 1a5a is joined to the cylinder liner 1a1a. Likewise, the beam-shaped portion 1a5e is joined to the cylinder liner 1a1d.

Furthermore, in the example illustrated in FIG. 7A to which the cylinder block 1 for an internal combustion engine of the first embodiment is applied, the metal section 1a is provided with crank journal portions 1a6a, 1a6b, 1a6c, 1a6d and 1a6e that slide in contact with crank journals (not illustrated). In detail, the crank cap bolt female screw portions 1a3a and 1a3b are connected via the crank journal portion 1a6a. The crank cap bolt female screw portions 1a3c and 1a3d are connected via the crank journal portion 1a6b. The crank cap bolt female screw portions 1a3e and 1a3f are connected via the crank journal portion 1a6c. The crank cap bolt female screw portions 1a3g and 1a3h are connected via the crank journal portion 1a6d. The crank cap bolt female screw portions 1a3i and 1a3j are connected via the crank journal portion 1a6e.

That is, in the example illustrated in FIG. 8A to which the cylinder block 1 for an internal combustion engine of the first embodiment is applied, the columnar portion 1a4c and the columnar portion 1a4d (see FIG. 7A) that are integrated with the beam-shaped portion 1a5b are also integrated with the cylinder liners 1a1a and 1a1b, and are also integrated with the crank journal portion 1a6b. Likewise, the columnar portion 1a4e and the columnar portion 1a4f (see FIG. 7A) that are integrated with the beam-shaped portion 1a5c are also integrated with the cylinder liners 1a1b and 1a1c, and are also integrated with the crank journal portion 1a6c. The columnar portion 1a4g and the columnar portion 1a4h (see FIG. 7A) that are integrated with the beam-shaped portion 1a5d are also integrated with the cylinder liners 1a1c and 1a1d, and are also integrated with the crank journal portion 1a6d.

Further, in the example illustrated in FIG. 8A to which the cylinder block 1 for an internal combustion engine of the first embodiment is applied, the columnar portions 1a4a and 1a4b that are integrated with the beam-shaped portion 1a5a are also integrated with the cylinder liner 1a1a, and are also integrated with the crank journal portion 1a6a. Likewise, the columnar portion 1a4i and the columnar portion 1a4j (see FIG. 7A) that are integrated with the beam-shaped portion 1a5e are also integrated with the cylinder liners 1a1d, and are also integrated with the crank journal portion 1a6e.

The portions of the metal section 1a that are other than the cylinder liners 1a1a, 1a1b, 1a1c and 1a1d can be formed with a ferrous metal material, or a metal material having a strength equivalent to the ferrous metal material, for example.

In one example to which the cylinder block 1 for an internal combustion engine of the first embodiment is applied, a plurality of portions of the metal section 1a can be integrated by, for example, joining the portions. In another example to which the cylinder block 1 for an internal combustion engine of the first embodiment is applied, the metal section 1a can be formed with a 3D printer for metals that forms a three-dimensional structure, for example, instead.

In the example illustrated in FIGS. 4, 5, 8A and 8B to which the cylinder block 1 for an internal combustion engine of the first embodiment is applied, at the time of producing the cylinder block 1 for an internal combustion engine, the water jacket outer wall member 1c made of a resin illustrated in FIGS. 4 and 5 is jointed to outer circumferential surfaces of the cylinder liners 1a1a, 1a1b, 1a1c and 1a1d of the metal section 1a illustrated in FIGS. 8A and 8B, and the metal section 1a and the water jacket outer wall member 1c are thus integrated. As a result, the water jacket 1d (see FIGS. 4 and 5) is formed between the outer circumferential surfaces of the cylinder liners 1a1a, 1a1b, 1a1c and 1a1d of the metal section 1a and the water jacket outer wall member 1c.

Next, the metal section 1a and the water jacket outer wall member 1c that have been integrated as described above are wrapped by casting with a casting resin material that is used to form the resin section 1b (see FIGS. 1, 2 and 3), so that the cylinder block 1 for an internal combustion engine illustrated in FIGS. 1, 2 and 3 is formed.

The cylinder block 1 for an internal combustion engine of the first embodiment has the resin section 1b, and can therefore be reduced in weight compared with a cylinder block that is entirely formed with a metal material. Further, the thermal insulation performance of the cylinder liners 1a1a, 1a1b, 1a1c and 1a1d can be enhanced by the resin section 1b, as a result of which, the warming-up performance of the internal combustion engine (not illustrated) to which the cylinder block 1 is applied can be enhanced, and fuel consumption can be reduced.

Further, the cylinder block 1 for an internal combustion engine of the first embodiment has the resin section lb, and therefore can enhance the sound insulation performance compared with the cylinder block that is entirely formed with a metal material.

As described above, in the example illustrated in FIGS. 4, 5, 8A and 8B to which the cylinder block 1 for an internal combustion engine of the first embodiment is applied, the metal section 1a and the water jacket outer wall member 1c are integrated by joining the water jacket outer wall member 1c made of a resin and the outer circumferential surfaces of the cylinder liners 1a1a, 1a1b, 1a1c and 1a1d. However, in another example to which the cylinder block 1 for an internal combustion engine of the first embodiment is applied, the metal section 1a and the water jacket outer wall member 1c can be integrated by forming the water jacket outer wall member 1c using an injection molding with the cylinder liners 1a1a, 1a1b, 1a1c, 1a1d being inserted in an injection molding die.

As described above, the cylinder block 1 for an internal combustion engine of the first embodiment is configured by the metal section 1a (see FIGS. 4, 8A and 8B) and the resin section 1b (see FIG. 1). Further, in the cylinder block 1 for an internal combustion engine of the first embodiment, the head bolt female screw portion 1a2c that is formed with a metal material and the crank cap bolt female screw portion 1a3c that is formed with a metal material are joined and integrated with each other with, interposed therebetween, the columnar portion 1a4c that is formed with a metal material, as illustrated in FIG. 3, for example.

Consequently, when a large upward load is applied to the head bolt female screw portion 1a2c by a large fastening force of the head bolt (not illustrated) in the cylinder block 1 for an internal combustion engine of the first embodiment, the load is received by the columnar portion 1a4c. That is, the load is not directly applied to the resin section 1b. Further, when a large downward load is applied to the crankshaft (not illustrated) by a combustion pressure, and with this, a large downward load is applied to the crank cap bolt female screw portion 1a3c, the load is received by the columnar portion 1a4c. That is, the load is not directly applied to the resin section 1b. As a result, the cylinder block 1 for an internal combustion engine of the first embodiment can reduce the possibility that the resin section 1b of the cylinder block 1 is deformed by a large fastening force of the head bolt or a combustion pressure.

Furthermore, in the cylinder block 1 for an internal combustion engine of the first embodiment, the cylinder liner 1a1a is integrated with the columnar portions 1a4a, 1a4b, 1a4c and 1a4d (see FIG. 6) that are formed with a metal material, with the beam-shaped portions 1a5a and 1a5b interposed therebetween, as illustrated in FIG. 8A, for example.

Consequently, when a downward load that pushes the cylinder liner 1a1a is applied to the cylinder liner 1a1a via a head gasket (not illustrated) at the time of fastening of the head bolt in the cylinder block 1 for an internal combustion engine of the first embodiment, the load is received by the columnar portions 1a4a, 1a4b, 1a4c and 1a4d. As a result, in the cylinder block 1 for an internal combustion engine of the first embodiment, deformation of the cylinder liner 1a1a can be restrained compared with an example where the downward load that pushes the cylinder liner 1a1a at the time of fastening of the head bolt is applied to only the cylinder liner 1a1a.

Further, as described above, in the cylinder block 1 for an internal combustion engine of the first embodiment, the cylinder liners 1a1a and 1a1b are joined via the beam-shaped portion 1a5b as illustrated in FIG. 8A, for example. That is, the cylinder liner 1a1a and the beam-shaped portion 1a5b are joined to each other, and further, the beam-shaped portion 1a5b and the cylinder liner 1a1b are joined to each other. Consequently, in the cylinder block 1 for an internal combustion engine of the first embodiment, an outer circumferential surface of a cylindrical first cylinder liner and an outer circumferential surface of a cylindrical second cylinder liner are directly joined to each other, and the strength of the joint between the cylinder liner 1a1a and the cylinder liner 1a1b can be enhanced compared with an example where the surface of the joint between the first cylinder liner and the second cylinder liner is very small.

Furthermore, in the cylinder block 1 for an internal combustion engine of the first embodiment, as illustrated in FIG. 8A, for example, the head bolt female screw portions 1a2c and 1a2d are provided, and the head bolt female screw portions 1a2c and 1a2d are formed in the beam-shaped portion 1a5b and are integrated with the beam-shaped portion 115b. Consequently, in the cylinder block 1 for an internal combustion engine of the first embodiment, the rigidity of the cylinder block 1 with respect to the fastening force of the head bolt (not illustrated) can be enhanced compared with an example where the head bolt female screw portion 1a2c and the head bolt female screw portion 1a2d are configured as separate metal sections.

Further, in the cylinder block 1 for an internal combustion engine of the first embodiment, as illustrated in FIG. 6, for example, the crank cap bolt female screw portions 1a3c and 1a3d are provided, and the crank cap bolt female screw portions 1a3c and 1a3d are connected via the crank journal portion 1a6b. Consequently, in the cylinder block 1 for an internal combustion engine of the first embodiment, the rigidity of the cylinder block 1 with respect to a combustion pressure can be enhanced compared with an example where the crank cap bolt female screw portion 1a3c and the crank cap bolt female screw portion 1a3d are configured as separate metal portions.

Furthermore, in the cylinder block 1 for an internal combustion engine of the first embodiment, as illustrated in FIG. 6, for example, the columnar portion 1a4c that connects the head bolt female screw portion 1a2c and the crank cap bolt female screw portion 1a3c, and the columnar portion 1a4d that connects the head bolt female screw portion 1a2d and the crank cap bolt female screw portion 1a3d are integrated via the beam-shaped portion 1a5b and the crank journal portion 1a6b.

Consequently, in the cylinder block 1 for an internal combustion engine of the first embodiment, the rigidity of the cylinder block 1 with respect to the fastening force of the head bolt and the combustion pressure can be enhanced compared with an example where the columnar portion 1a4c and the columnar portion 1a4d are configured as separate metal portions.

Furthermore, as described above, in a method for manufacturing the cylinder block 1 for an internal combustion engine of the first embodiment, the water jacket outer wall member 1c (see FIGS. 4 and 5) is not formed with a casting resin material at the time of the metal section 1a (see FIGS. 4 and 8A) being wrapped by casting with the casting resin material that forms the resin section lb (see FIGS. 1, 2 and 3), but the water jacket outer wall member 1c which is formed with a resin material different from the casting resin material is joined to the metal section 1a before the metal section 1a is wrapped by casting with the casting resin material forming the resin section 1b. Furthermore, after the water jacket outer wall member 1c is joined to the metal section 1a, the metal section 1a and the water jacket outer wall member 1c are wrapped by casting with the casting resin material. Consequently, in the method for producing the cylinder block 1 for an internal combustion engine of the first embodiment, the sealing performance of the water jacket 1d (see FIGS. 2, 4 and 5) can be enhanced compared with an example illustrated in FIG. 8 in JP 05-296103 A.

In the example illustrated in FIGS. 1 and 4, the four cylinders #1, #2, #3 and #4 are provided in the cylinder block 1 for an internal combustion engine of the first embodiment, but in another example, the cylinder block 1 for an internal combustion engine of the present disclosure can be applied to a cylinder block having an arbitrary number of cylinders, which are one or more cylinders, instead of the above.

In the example illustrated in FIG. 7B to which the cylinder block 1 for an internal combustion engine of the first embodiment is applied, support portions 1a4a2, 1a4b2, 1a4c1 and 1a4d1 that support the bottom portion 1a1a1 of the cylinder liner 1a1a (see FIGS. 8A and 8B), support portions 1a4c2, 1a4d2, 1a4e1 and 1a4f1 that support the bottom portion 1a1b1 of the cylinder liner 1a1b (see FIGS. 8A and 8B), support portions 1a4e2, 1a4f2, 1a4g1 and 1a4h1 that support the bottom portion 1a1c1 of the cylinder liner 1a1c (see FIGS. 8A and 8B), and support portions 1a4g2, 1a4h2, 1a4i1 and 1a4j1 that support the bottom portion 1a1d1 of the cylinder liner 1a1d (see FIGS. 8A and 8B) are provided.

In detail, the support portion 1a4a2 is provided at the columnar portion 1a4a, and the support portion 1a4b2 is provided at the columnar portion 1a4b. The support portions 1a4c1 and 1a4c2 are provided at the columnar portion 1a4c, and the support portions 1a4d1 and 1a4d2 are provided at the columnar portion 1a4d. The support portions 1a4e1 and 1a4e2 are provided at the columnar portion 1a4e, and the support portions 1a4f1 and 1a4f2 are provided at the columnar portion 1a4f. The support portions 1a4g1 and 1a4g2 are provided at the columnar portion 1a4g, and the support portions 1a4h1 and 1a4h2 are provided at the columnar portion 1a4h. The support portion 1a4i1 is provided at the columnar portion 1a4i, and the support portion 1a4j1 is provided at the columnar portion 1a4j.

Consequently, when the cylinder liners 1a1a and 1a1b are pushed downward via the head gasket (not illustrated) at the time of fastening of the head bolt (not illustrated), the cylinder block 1 for an internal combustion engine of the first embodiment can reduce the possibility of the cylinder liners 1a1a and 1a1b being deformed, in detail, the possibility of the cylinder liners 1a1a and 1a1b being separated from the beam-shaped portion 1a5b (see FIGS. 8A and 8B), compared with an example where the support portions 1a4c1 and 1a4c2 are not provided at the columnar portion 1a4c and the support portions 1a4d1 and 1a4d2 are not provided at the columnar portion 1a4d.

In the example illustrated in FIGS. 4, 7A, 7B, 8A and 8B to which the cylinder block 1 for an internal combustion engine of the first embodiment is applied, the metal section 1aincludes the cylinder liners 1a1a, 1a1b, 1a1c and 1a1d, the head bolt female screw portions 1a2a, 1a2b, 1a2c, 1a2d, 1a2e, 1a2f, 1a2g, 1a2h, 1a2i and 1a2j, the crank cap bolt female screw portions 1a3a, 1a3b, 1a3c, 1a3d, 1a3e, 1a3f, 1a3g, 1a3h, 1a3i and 1a3j, and the columnar portions 1a4a, 1a4b, 1a4c, 1a4d, 1a4e, 1a4f, 1a4g, 1a4h, 1a4i and 1a4j, and these components are integrated. However, in an another example (an example corresponding to claim 1) to which the cylinder block 1 for an internal combustion engine of the first embodiment is applied, instead of the above, the metal section 1a may include the cylinder liner 1a1a, the head bolt female screw portion 1a2a, the crank cap bolt female screw portion 1a3a and the columnar portion 1a4a, the cylinder liner 1a1a may be integrated with the columnar portion 1a4a, and the other metal components may be separated from the metal section 1a.

In the example illustrated in FIGS. 4, 7A, 7B, 8A and 8B to which the cylinder block 1 for an internal combustion engine of the first embodiment is applied, the metal section 1a includes the cylinder liners 1a1a, 1a1b, 1a1c and 1a1d, the beam-shaped portions 1a5a, 1a5b, 1a5c, 1a5d and 1a5e, the crank journal portions 1a6a, 1a6b, 1a6c, 1a6d and 1a6e, the head bolt female screw portions 1a2a, 1a2b, 1a2c, 1a2d, 1a2e, 1a2f, 1a2g, 1a2h, 1a2i and 1a2j, the columnar portions 1a4a, 1a4b, 1a4c, 1a4d, 1a4e, 1a4f, 1a4g, 1a4h, 1a4i and 1a4j, the crank cap bolt female screw portions 1a3a, 1a3b, 1a3c, 1a3d, 1a3e, 1a3f, 1a3g, 1a3h, 1a3i and 1a3j, and these components are integrated. However, in an another example (an example corresponding to claim 2 as originally filed) to which the cylinder block 1 for an internal combustion engine of the first embodiment is applied, instead of the above, the metal section la may include the cylinder liners 1a1a and 1a1b, the beam-shaped portion 1a5b, the crank journal portion 1a6b, the head bolt female screw portions 1a2c and 1a2d, the columnar portions 1a4c and 1a4d, and the crank cap bolt female screw portions 1a3c and 1a3d, these components may be integrated, and the other metal components may be separated from the metal section 1a.

In the example illustrated in FIGS. 7A, 8A and 8B to which the cylinder block 1 for an internal combustion engine of the first embodiment is applied, a support portion 1a4a2 is provided at the columnar portion 1a4a of the metal section 1a, a support portion 1a4b2 is provided at the columnar portion 1a4b of the metal section 1a, support portions 1a4c1 and 1a4c2 are provided at the columnar portion 1a4c of the metal section 1a, support portions 1a4d1 and 1a4d2 are provided at the columnar portion 1a4d of the metal section 1a, support portions 1a4e1 and 1a4e2 are provided at the columnar portion 1a4e of the metal section 1a, support portions 1a4f1 and 1a4f2 are provided at the columnar portion 1a4f of the metal section 1a, support portions 1a4g1 and 1a4g2 are provided at the columnar portion 1a4g of the metal section 1a, support portions 1a4h1 and 1a4h2 are provided at the columnar portion 1a4h of the metal section 1a, a support portion 1a4i1 is provided at the columnar portion 1a4i of the metal section 1a, and a support portion 1a4j1 is provided at the columnar portion 1a4j of the metal section 1a. However, in another example (an example corresponding to claim 3 as originally filed) to which the cylinder block 1 for an internal combustion engine of the first embodiment is applied, instead of the above, the metal section 1a may include the cylinder liners 1a1a and 1a1b, the beam-shaped portion 1a5b, the crank journal portion 1a6b, the head bolt female screw portions 1a2c and 1a2d, the columnar portions 1a4c and 1a4d, and the crank cap bolt female screw portions 1a3c and 1a3d. Also, the support portions 1a4c1 and 1a4c2 may be provided at the columnar portion 1a4c, and the support portions 1a4d1 and 1a4d2 may be provided at the columnar portion 1a4d. Furthermore, these components may be integrated, and the other metal components may be separated from the metal section 1 a.

In a second embodiment, the first embodiment and the respective examples described above can be properly combined.

What is claimed is:

1. A cylinder block for an internal combustion engine, the cylinder block comprising:
a metal section formed with a metal material; and
a resin section,
wherein the metal section includes:
a cylinder liner;
a head bolt female screw portion that is screwed onto a male screw portion of a head bolt that fastens the cylinder block and a cylinder head;
a crank cap bolt female screw portion that is screwed onto a male screw portion of a crank cap bolt that fastens the cylinder block and a crank cap; and
a columnar portion that connects the head bolt female screw portion and the crank cap bolt female screw portion, and
wherein the cylinder liner and the columnar portion are integrated with each other.

2. The cylinder block according to claim 1,
wherein the cylinder liner includes at least a first cylinder liner and a second cylinder liner,
wherein the metal section includes:
a beam-shaped portion that is disposed between the first cylinder liner and the second cylinder liner and that joins the first cylinder liner and the second cylinder liner; and
a crank journal portion that slides in contact with a crank journal,
wherein the head bolt female screw portion includes a first head bolt female screw portion that is disposed at one end portion of the beam-shaped portion, and a second head bolt female screw portion that is disposed at the other end portion of the beam-shaped portion,
wherein the columnar portion includes a first columnar portion and a second columnar portion,
wherein the crank cap bolt female screw portion includes a first crank cap bolt female screw portion that is connected to the first head bolt female screw portion via the first columnar portion, and a second crank cap bolt female section that is connected to the second head bolt female screw portion via the second columnar portion,
wherein the crank journal portion connects the first crank cap bolt female screw portion and the second crank cap bolt female screw portion, and
wherein the first cylinder liner, the second cylinder liner, the beam-shaped portion, the first columnar portion, the second columnar portion and the crank journal portion are integrated with each other.

3. The cylinder block according to claim 2,
wherein the first columnar portion includes a first support portion that supports a bottom portion of the first cylinder liner, and a second support portion that supports a bottom portion of the second cylinder liner, and
wherein the second columnar portion includes a third support portion that supports the bottom portion of the first cylinder liner, and a fourth support portion that supports the bottom portion of the second cylinder liner.

4. A method for producing the cylinder block according to claim 1,
wherein, after a water jacket outer wall member made of a resin for forming a water jacket and the metal section are integrated with each other, the metal section and the water jacket outer wall member are wrapped by casting with a casting resin material that forms the resin section.
